(19) United States
(12) Patent Application Publication
(10) Pub. No.: US 2022/0377594 A1
(43) Pub. Date: Nov. 24, 2022

(54) METHOD AND SYSTEM FOR ENHANCED STEERING AND TRAFFIC LOAD BALANCING IN WIRELESS MESH NETWORKS

(71) Applicant: ALTICE LABS, S.A., Aveiro (PT)

(72) Inventors: Paulo José HENRIQUES DE JESUS, Aveiro (PT); Nelson José VALENTE DA SILVA, Aveiro (PT); João Luís CARVALHO FERREIRA RIBEIRO, Viseu (PT); João Pedro FERREIRA E PEREIRA, Gafanha da Nazaré (PT); Nuno Miguel ABREU LUÍS, Lisboa (PT); Susana Isabel BARRETO DE MIRANDA SARGENTO, Ílhavo (PT)

(21) Appl. No.: 17/765,375

(22) PCT Filed: Sep. 3, 2019
(86) PCT No.: PCT/PT2019/000006

§ 371 Date: Mar. 30, 2022

(51) Int. Cl. H04W 28/02; H04W 40/22

(52) U.S. Cl. CPC H04W 28/0236; H04W 28/021; H04W 28/0289; H04W 40/22

(57) ABSTRACT

The present invention provides a method and system for managing the connections of multiple stations in a Wi-Fi mesh network, using station steering to optimize the overall throughput of the network.

The stations are proactively steered depending on the link quality, the network topology and wireless medium occupation, as well as the different equipment capabilities, to ultimately provide the best available throughput.

This invention also aims to detect crowded Access Points or frequency bands, and steer stations accordingly towards an efficient load control and traffic management between nodes/Access Points and improved quality of experience.

### FIELD OF THE INVENTION

The present invention is enclosed in the area of mesh networks. Particularly, the present invention relates to a method and system for managing the operation of wireless mesh networks. More particularly, the present invention describes a method and system for enhanced steering and traffic load balancing in wireless mesh networks.

### PRIOR ART

Home wireless networks, a particular scenario of Wireless Local Area Networks (WLANs), target indoor environments with several radio propagation obstacles, such as walls and furniture to name a few. These obstacles reduce the signal quality emitted by an access point (AP), therefore reducing the coverage of such equipment. Due to the regulatory bodies, as well as the different transmission characteristics of both APs and stations (STA)/client devices, increasing the transmission power is not a valid solution to improve the wireless coverage. A more effective way to solve this problem is to bring additional APs to the network, forming a wireless mesh network. In a home wireless network, the main AP is denoted as Root AP, responsible to communicate with the outside world (e.g. Internet), and the remaining APs are denoted as Extenders and, if used, they establish the connection between the Root AP and the STA devices. Extenders can be connected to the Root AP and/or between themselves through wireless links or through cable, depending on the configuration of the scenario, thus creating backhaul links.

From the several challenges associated with the operation of wireless mesh networks, one of the most critical is the steering of the STA device, i.e., how to manage the connections of the several STAs among the available APs (Root AP and Extenders). However, choosing between the Root AP and one of the Extenders is not the only choice available. With the latest generation of Wi-Fi APs, two wireless bands can be used, 2.4 and 5 GHz, each one with distinguished characteristics: the first one typically enables higher coverage while the second one offers higher throughput. In a conventional Wi-Fi mesh network, a STA device remains associated with an AP if the link quality, given by the Received Signal Strength Indicator (RSSI), is better than any other link with any other AP in the network. However, the AP with the best link quality may not provide the best Quality of Service, and consequently, Quality of Experience. For example, the number of STAs connected to a specific AP can be too high that, although the link quality is considered of high quality, the resulting airtime for each STA device is considerably small.

Traditional steering methods are independently-based, i.e., the STA device usually selects the AP that provides the highest signal strength in comparison to the signal strength provided by other APs without considering the effects of an eventual steering in the performance of the new AP, and consequently, on the network. More recently, several works have proposed alternative STA steering mechanisms whose decision takes place in the AP. For that, the STA sends its neighbouring information to the AP in response to a beaconing message sent by the AP to the STA. Such approach is not transparent to the STA device in the sense that he is the one to provide the required information to the AP of interest. Finally, other approaches admit that all the APs in the network are allowed to exchange STA's information using the backhaul links. Following this approach, the steering decision may occur in any of the AP, Extender or Root AP.

### PROBLEM TO BE SOLVED

All the aforementioned solutions, although providing different levels of steering decisions, they lack on finding a steering criterion that takes into consideration not only the link quality, but also the network topology, the bandwidth, the capabilities of each element, AP and STA device, and other important parameters, and proactively steer the STAs in an integrated way from the network's point of view.

The present solution intends to innovatively overcome such issues, providing an efficient method and system for steering clients of a Wi-Fi mesh network to the best AP and wireless band.

### SUMMARY OF THE INVENTION

It is therefore an object of the present invention to produce a method and system for optimizing the link quality of clients connected to a wireless mesh network, either through band steering (2.4 GHz or 5 GHz) or AP steering (Root AP or Extenders).

In order to achieve that, the present solution makes use of two logical entities, a centralized controller that acts as a master and has the vision of the entire network, and distributed agent entities that act as slaves and exchange information with the controller, to build a mesh architecture. In this configuration, the Root AP typically contains the controller and may also contain an agent entity, while the Extenders are always comprised by agent entities.

### DESCRIPTION OF FIGURES

FIG. 1 is a schematic of multiple clients in a Wi-Fi mesh network.

FIG. 2 is a flow chart of the overall behaviour of the present invention;

FIG. 3 is a flow chart of the link optimization routine;

FIG. 4 is a flow chart of the identification of saturated STAs;

FIG. 5 is a flow chart of the load balancing routine.

FIG. 6 depicts the process of a steer request received by the Steer Manager.

FIG. 7 illustrates the process responsible for detecting weak STAs.

### DETAILED DESCRIPTION

The present invention provides a method and system for managing the connections of multiple STAs in a Wi-Fi mesh network, using STA steering to optimize the overall throughput of the network. The STAs are proactively steered depending on the, link quality, the network topology and wireless medium occupation, as well as the different equipment capabilities, to ultimately provide the best available throughput. This invention also aims to detect crowded APs or frequency bands, and steer STAs accordingly towards an efficient load control and traffic management between APs and improved quality of experience.

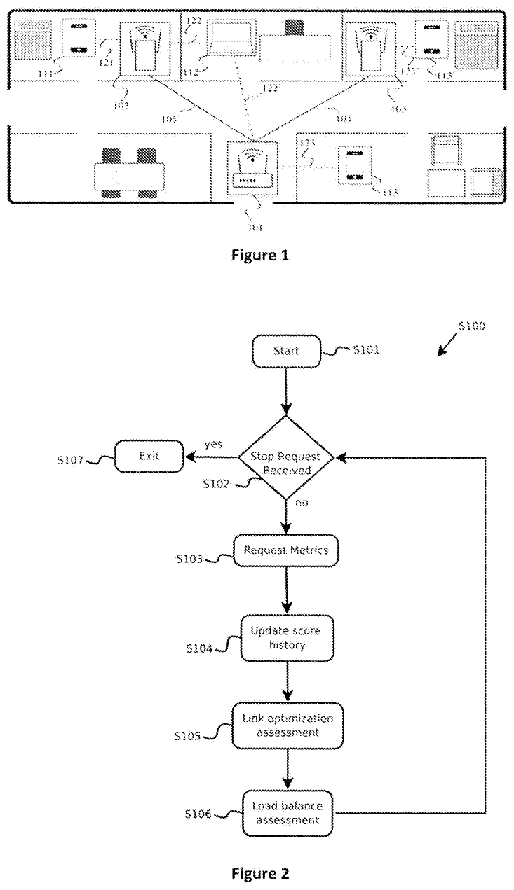

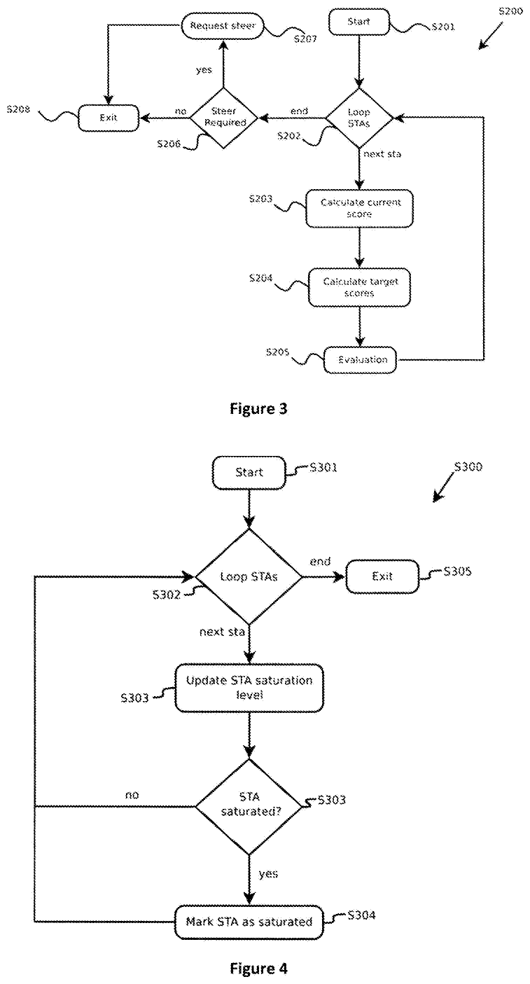

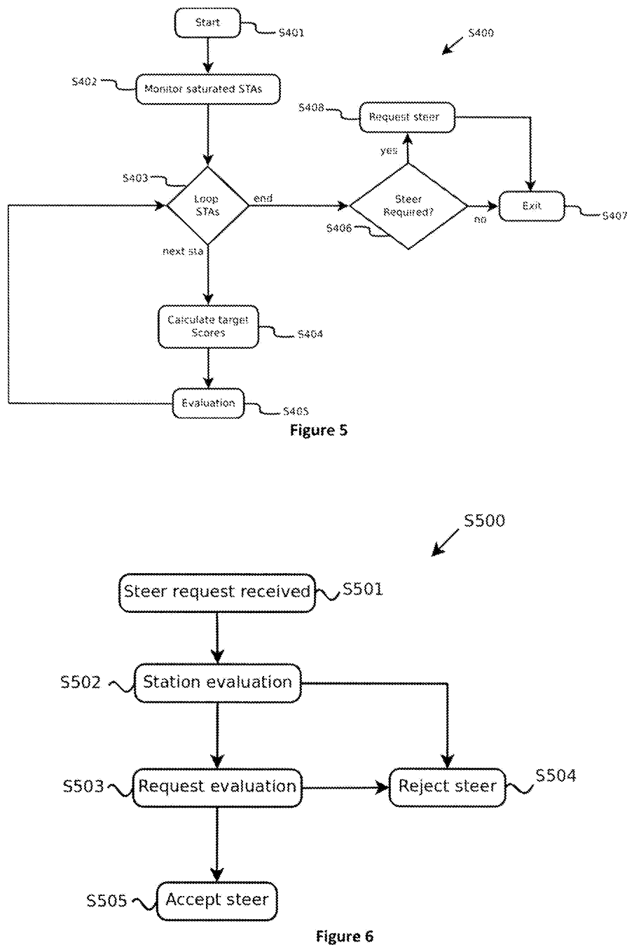

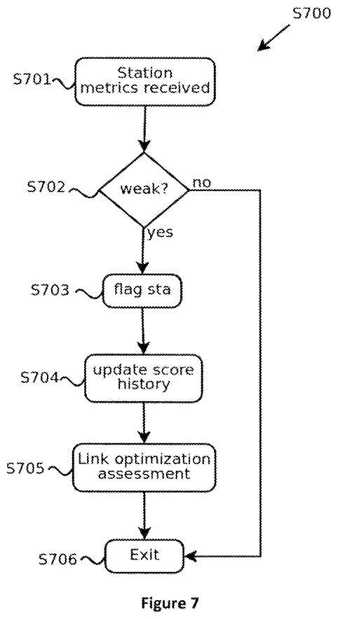

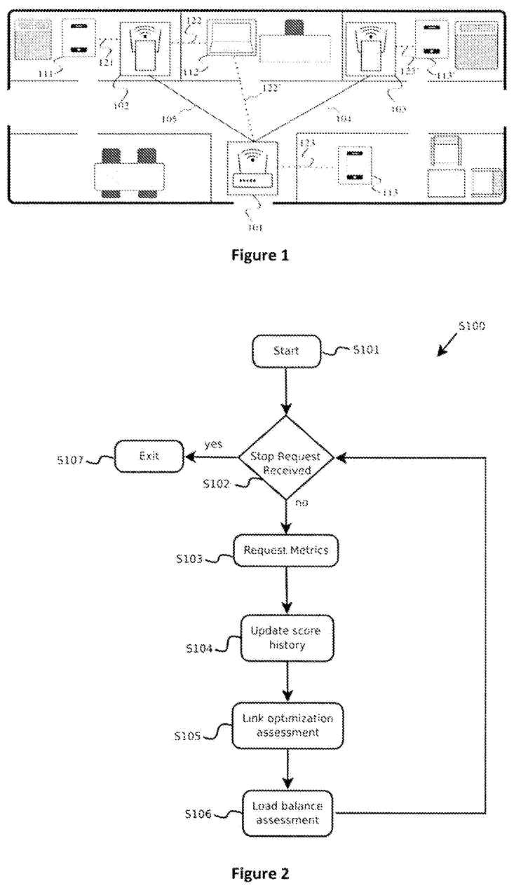

FIG. 1 provides a high-level view of a possible residential wireless mesh network use case where this innovation can be applied. Here, the Root AP (101) is typically placed indoors and provides the wireless link that allows both STA devices and Extenders to connect to the network, The solid lines (104 and 105) denote the wireless backhaul connection that is stablished between the Root AP and the Extenders (102 and 103). The dotted lines (121, 122 and 123) denote the wireless fronthaul connection that is stablished between the STA devices (111, 112 and 113) and the APs (Root AP or Extenders), A STA mobility scenario is also illustrated, where STA (113) is initially connected to the Root AP (101) and after moving into another physical location (such as the bed room), the same STA (113′) in now connected to the Extender (103). Finally, a link optimization scenario is also depicted, where a STA device (112) initially connects to the wireless network via an Extender (102) and then is steered to connect directly to the Root AP (122′).

### Base Algorithm Routine

FIG. 2 describes the process S100, which consists on the base algorithm that handles the steer management of STAs in the network. The base algorithm routine is executed in the Root AP and consists of a loop running continuously until instructed otherwise. The first stage is responsible for ordering Extenders AP to report STAs' message status therein connected, to the Root AP (S103). The report is executed by the agent entities of the Extenders AP and includes metrics related to the connected STAs or the status of the wireless medium in which the Root AP is located. The Root AP waits for a predefined period of time until the requested metrics are received. In order to avoid spontaneous peaks and mitigate metric variations, a score history is kept. Using the metrics received, the Root AP will compute values to be used in Link Optimization and Load Balance routines, to be executed in said Root AP, and is updated in every iteration (S104).

The Root AP will then use the values computed in S104 to decide which action can and should be taken regarding Link Optimization (S105) and Load Balance (S106) processes.

### Link Optimization Assessment

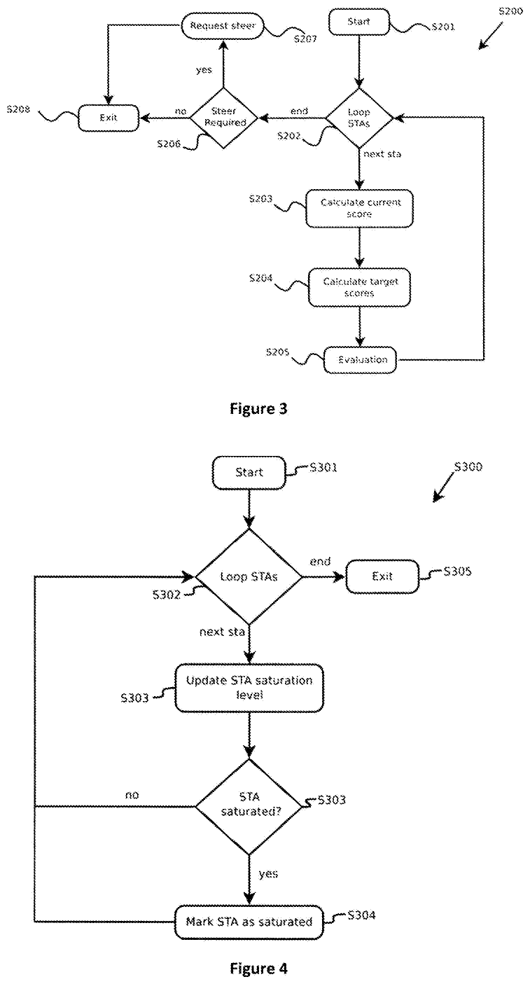

FIG. 3 describes the link optimization process to be executed in the Root AP, by the Link Optimization routine. In the context of this process (S200), the quality of a link (named as score) is classified by the maximum possible throughput that a given STA would have via a given AP and band. In step S202, the process S200 enters in a loop, where all the connected STA links—connecting a STA to an AP—are evaluated. Then, the score for the current link, connecting a STA to its AP, is computed (S203). After that, a score is computed for every pair of {STA, fronthaul Basic Service Set (BSS)} (S204). Links to 5 GHz BSS and via the Root AP are preferred, as they result in higher throughput gains. Links to 2.4 GHz are used for higher distances to APs or for older devices, while links to Extenders are available for STA devices far away from the Root AP. At step S205, two different evaluations are performed:
I. The first is to check if the highest score of a STA to a target AP is higher than the score of the STA to the current AP, i.e, if the STA would get a higher maximum throughput than in the current link.
II. The second is to evaluate if the throughput gain is better than in previous cases where the first condition was true.

In step S206, the link optimization routine S200 checks if there is any steer required, following the evaluation in step S205. If required, a steer is requested for the pair {STA, target BSS}with the highest score. The link optimization assessment ends in step S208.

To estimate the maximum throughput that a STA will achieve when connected to a different AP, the following inputs are used:
i. Signal Strength;
ii. Maximum backhaul physical data rate;
iii. Estimation of maximum theoretical physical data rate according to the STA and AP's capabilities.

The estimation of maximum theoretical physical data rate uses the following formula:

$${E}_{phy} ( s , {b}_{t} ) = \{ \begin{matrix}\frac{{M}_{phy} ( s , {b}_{t} )}{{2}^{H ( {b}_{t} )}} , & if {I}_{FH} ( {b}_{t} ) = {I}_{BH} ( {b}_{t} ) \\ {M}_{phy} ( s , {b}_{t} ) , & if {I}_{FH} ( {b}_{t} ) \neq {I}_{BH} ( {b}_{t} )\end{matrix}$$

where E_{phy} represents the estimation, s represents the STA, bₜ represents the target BSS, M_{phy}(s, bₜ) represents the maximum theoretical physical data rate that can be obtained on the link between the STA s and the target BSS bₜ, according to each other's capabilities. H(bₜ) represents the distance of the AP that advertises the 855 in relation to the Root AP, in hops. I_{FH}(bₜ)refers to the interface that is used to advertise the target BSS (fronthaul), I_{BH}(bₜ) represents the interface used for backhaul communications. This model is valid for equipment with a shared radio interface for fronthaul and backhaul communications. These inputs are combined and define a curve through a fitting function, which results in a formula that is capable of estimating the maximum throughput that a STA will be able to achieve when connected to a set AP, in the described conditions.

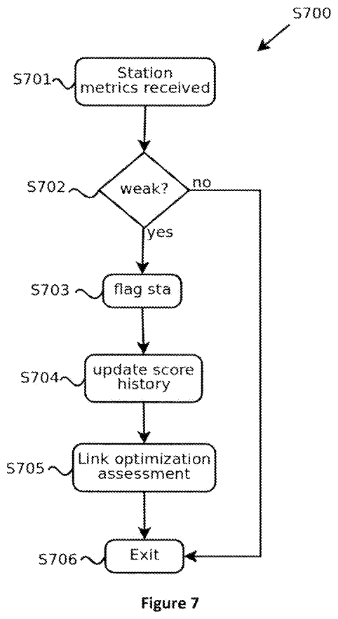

The Link Optimization routine is also programmed to detect weak STAs (S700) by means of the process described in FIG. 7. When a message status is received (S701), containing STA's metrics response, the network metrics are then used to check if the STA's link is weak (S702). This verification is based solely on RSSI (Received Signal Strength Indicator). If the STA's link is determined as weak, it is flagged and will be handled by a separate monitor entity. On the other hand, if a weak STA is no longer weak, its weak flag is removed (S702).

Weak STAs rely on the Link Optimization routine to maintain connectivity. In order for the Link Optimization process to provide a faster response to the weak STAs' fading link, the Link Optimization routine score computing (S704) and assessment (S705) is performed when the STAs' metrics are received.

To provide a quicker response, weak STAs' metric requests are not handled by the base algorithm routine (S103) as regular STAs are; instead a separate entity, named Monitor Entity, is responsible for requesting metrics for these associated STAs, in a higher frequency in relation to the base algorithm routine.

Weak STAs are only subject to the Link Optimization routine and the Load balance routine will not act or consider them.

### Load Balance Assessment

The load balance routine is comprised of two different subprocesses:
I. Saturated STA detection:
   A STA is considered saturated if it is unable to achieve more throughput because the medium is overloaded;
II. Throughput prediction:
   If a saturated STA is identified, a prediction score (i.e, throughput) is computed for each potential target AP.

### Saturated STA Detection

This subprocess is depicted on FIG. 4. In step S302, the process S300 enters a loop, where all connected STAs' links are evaluated to check for saturated links. This process updates the saturation level of a STA (S303). The saturation level is related to the amount of times a STA is classified as saturated within a pre-defined time frame, Then, the saturation level is evaluated to check whether or not the STA is saturated (S303). In the case of a positive answer, the STA is marked as saturated (S304). Using this approach, to ultimately classify a STA as saturated, a client needs to be detected as being saturated multiple times within a specific time frame, which reduces the influence of data transmission spikes.

The detection itself takes into account a wide range of inputs, which not only includes metrics from the STA under evaluation, but also from other STAs in the network.

From the STA under evaluation:
I. Airtime
II. Transmission opportunity
III. Retransmission rate
IV. Physical data rate
V. Data rate
VI. Transmission failures
VII. Number of hops to Root AP
VIII. Band (2.4 GHz or 5 GHz)

From other STAs connected to the same AP:
Airtime
Data rate

Using all this information, some of these metrics are combined to derive the following:
Available airtime
Percentage of maximum airtime
Percentage of total data rate

The decision is accomplished using a classification tree with two classes: saturated or not saturated STAs. This is modelled in a conservative manner, as it is tuned to reduce false positives in detriment of true positives. The outcome of this approach is a slower identification of overloaded STAs, but also a more trustworthy overall classification.

### Throughput Prediction

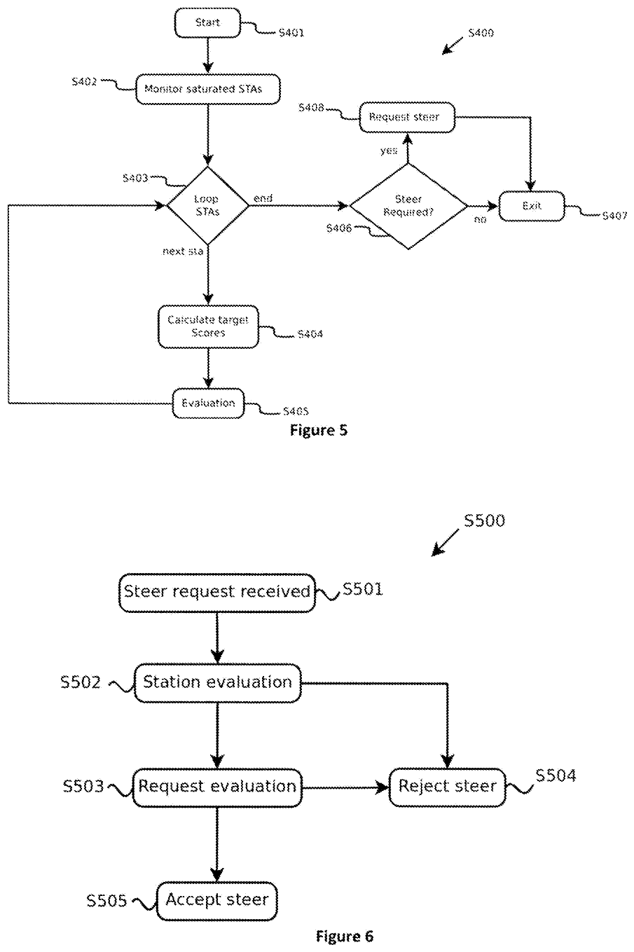

FIG. 5 describes the throughput prediction process. The process S400 is executed after process S300, and only starts if there are STAs marked as saturated. The STAs marked as saturated by process S300 are monitored for a specified amount of time (with a maximum of 50 seconds) (S402), During this step, all the relevant metrics corresponding to the STAs under evaluation are stored, After this, the process enters a loop involving all the STAs marked as saturated (S403). Here, a target score is calculated for all available APs (S404), followed by a subsequent evaluation (S405). In this step, two different evaluations are performed:
I. The first is to check if the highest score of a STA to a target AP is higher than the score of the STA to the current STA's throughput, measured during the monitoring phase (S402).
II. The second is to evaluate if the throughput gain is better than in previous cases where the first condition was true.

In step S406, the process S400 checks if there is any steer required, following the evaluation in step S405. If required, a steer is requested for the pair of STA and target AP where the throughput gain is the highest. The link optimization routine then ends its execution in step S407.

This process combines the estimation of the maximum throughput from the link optimization process S200 with metrics that characterize the medium occupation.

As such, the considered inputs are as follows:
I. Link optimization score (estimated maximum throughput);
II. Transmission opportunity;
III. Available airtime;
III. Retransmission rate;

In order to manage the steering of STA devices and also the hierarchy between Link Optimization and Load Balance routines' actions and steer requests, the Root AP comprises a Steer Manager entity. Such entity acts base on the current priorities:
1. Weak STA optimization
2. Load balance
3. Regular STA optimization

This entity is also responsible for allowing or denying the Link Optimization and Load Balance modules' actions on a particular STA, based on the STA's previous behaviour.

To perform these tasks, the Steer Manager entity maintains a queue of steer requests. For each request, a state is assigned accordingly. The following table describes these states:

| Steer state | Description |
|---|---|
| pending | request on queue to be sent |
| processing | request has been sent, waiting for reply |
| success | STA has been steered |
| failed | STA has not responded or has rejected the |
| | steer request |

In FIG. 6, S500 depicts the process of a steer request received by the Steer Manager. This request can be originated in the Link Optimization routine or in the Load Balance routine.

After the request is received, the Steer Manager checks if there is no current time penalty on the STA (S502). If a time penalty is in effect, the request will be rejected (S504). Otherwise, the Steer Manager will check if there are no conflicting requests (S503).

A new request will be rejected if an old similar request (same STA, same source BSS, same target BSS) with equal or higher priority in a pending or processing state exists. If the old request, as described previously, with a lower priority exists, the new request will be rejected if the old request is in the processing state (S504). If the old request is in the pending state, the old request will be deleted and the new request will be accepted (S505).

If a STA did not respond as expected to a steer request, this STA will be marked as misbehaved, for a predefined period of time. The steering type can be classified as:
BSS transition steer (IEEE 802.11v).
Legacy Steer by deauthentication of client from current BSS, and blacklisted by MAC address in every BSS that is not source or destination BSS.

Following a steer request, the behaviour or the STA device is not completely deterministic and in some cases, it can have an unexpected behaviour. To prevent unnecessary disconnects, every steer response is classified as one of the following:
Accept: The STA is steered and reports a successful steer;
Reject: The STA is not steered and reports a rejected steer;
Wrong BSS joined: The STA joins a BSS different from the target BSS;
Disconnect: The STA does not reconnect after a legacy blacklist;
Jump back: The STA is steered to the target BSS but soon returns to the source BSS;
Timeout: No response obtained for the steer request (the Extender has not carried out the order or IEEE 802.11v reject).

Using the steer response classification above, penalties are given accordingly:

| Conditions | Penalty |
|---|---|
| Steer timeout | low |
| Accept | low |
| Reject | mid |
| Random BSS | mid |
| Disconnect | high |

### DESCRIPTION OF THE EMBODIMENTS

The more general and advantageous configurations of the present invention are described in the Summary of the invention. Such configurations are detailed below in accordance with other advantageous and/or preferred embodiments of implementation of the present invention.

In a preferred embodiment of the method for enhanced steering and traffic load balancing in wireless mesh networks of the invention, it is comprised by the following steps:
i. Root AP instructs periodically, the Extenders AP to report STAs' message status;
ii. Root AP wait for a predefined period of time until the requested messages status are received;
iii. Root AP kept a score history of all the STAs' message status received from the Extenders AP and updates it as the message status are being received;
iv. Root AP uses the updated score history of the STAs connected to the Extenders AP as an input to a Link Optimization routine and to a Load Balance routine, in order to decide which action is to be taken;
v. the steps i. to iv. are executed in a continuous loop until instructions otherwise from the Root AP.

In another embodiment of the method of the present invention, combinable with the above described, the message status send by the Extenders AP to the Root AP includes metrics related to the connected STAs or the status of the wireless medium in which the Root AP is located.

In another embodiment of the method of the present invention, combinable with any above described, the Link Optimization routine is programmed to execute a link optimization process comprising the following steps:
i. Calculate the current score of a link; the score being, classified by the maximum throughput that a given STA would have via a given access point and band;
ii. Calculate target scores for every pair of {STA, fronthaul Basic Service Set};
iii. Evaluate if the highest score of a STA to a target AP is higher than the score of the STA to the current AP, and if so, evaluate if the throughput gain is better than in previous cases;
iv. Check if there is any steer required, following the step iii., and if required, a steer is requested for the pair {STA, target Basic Service Set}.

In another embodiment of the method of the present invention, combinable with any above described, the maximum throughput is estimated considering:
signal strength;
maximum backhaul physical data rate; and
estimation of maximum theoretical physical data rate according to a STA and AP's capabilities;
wherein, the estimation of maximum theoretical physical data rate is computed as follows:

$${E}_{phy} ( s , {b}_{t} ) = \{ \begin{matrix}\frac{{M}_{phy} ( s , {b}_{t} )}{{2}^{H ( {b}_{t} )}} , & if {I}_{FH} ( {b}_{t} ) = {I}_{BH} ( {b}_{t} ) \\ {M}_{phy} ( s , {b}_{t} ) , & if {I}_{FH} ( {b}_{t} ) \neq {I}_{BH} ( {b}_{t} )\end{matrix}$$

where E_{phy} represents the Estimation, s represents the STA, bₜ represents the target BSS, M_{phy}(s,bₜ) represents the maximum theoretical physical data rate that can be obtained on the link between the STA s and the target BSS bₜ, according to each other's capabilities; H(bₜ) represents the distance of the AP that advertises the BSS in relation to the Root AP, in hops; I_{FH}(bₜ) refers to the interface that is used to advertise the target BSS (fronthaul), I_{BH}(bₜ) represents the interface used for backhaul communications.

In another embodiment of the method of the present invention, combinable with any above described, the Link Optimization routine is further programmed to detect weak STAs based on the STA's metrics contained in the message status; said detection being based on the RSSI of the STA's link.

in another embodiment of the method of the present invention, combinable with any above described, weak STA's links are flagged and are handled by a Monitor Entity of the Link Optimization routine; said Monitor Entity being configured to:
to request the associated STA metrics for weak STAs in a higher frequency in relation to the requests of the base algorithm routine;
based on those requests, update the score history;
perform a link optimization assessment to evaluate if the weak STA is no longer weak; if so, the weak flag is removed.

In another embodiment of the method of the present invention, combinable with any above described, weak STAs are not considered by the Load Balance routine.

In another embodiment of the method of the present invention, combinable with any above described, the Load Balance routine is programmed to execute a load balance process comprised by two sequential stages:
i. Saturated STA detection stage, by assessing if the STA is unable to achieve more throughput because the medium is overloaded;
ii. Throughput prediction stage, executed if saturated STAs are identified, and where a prediction score is computed for each potential target AP.

In another embodiment of the method of the present invention, combinable with any above described, the saturated STA detection stage is executed for all connected STAs' links and comprises the following steps:
i. Determine the amount of times a STA is classified as saturated within a time frame;
ii. Evaluate the saturation level to check whether or not a STA is saturated;
iii. If the STA is saturated it is marked as saturated.

In another embodiment of the method of the present invention, combinable with any above described, the evaluation of the saturation level takes into account inputs including metrics from the STA under evaluation, such as
Airtime, transmission opportunity, retransmission rate, physical data rate, data rate, transmission failures, number of hops to Root AP and band;

and metrics from other STAs in the network, such as
Airtime and data rate;

in order to determine:
The available airtime;
The percentage of maximum airtime; and
The percentage of total data rate,

which are the inputs of a classification tree with two classes: saturated or not saturated STAs.

In another embodiment of the method of the present invention, combinable with any above described, the throughput prediction stage comprises the following steps:
i. Monitorization of saturated STAs for a specified amount of time, during which all the relevant metrics corresponding to the STAs under evaluation are stored;
ii. Once the monitoring phase has expired, a target score is calculated for all available Aps, followed by a subsequent 2-step evaluation:
   a. Check if the highest score of a saturated STA to a target AP is higher than the score of the STA to the current STA's throughput, measured during the monitoring phase;
   b. Evaluate if the throughput gain is better than in previous cases where the condition of step a. was true;
iii. Check if there is any steer required; if required, a steer is requested for the pair {STA, target AP} where the throughput gain is the highest.

In another embodiment of the method of the present invention, combinable with any above described, the estimation of the highest score of a saturated STA combines the estimation of the maximum throughput, of the link optimization routine, with metrics that characterize the medium occupation such as transmission opportunity, available airtime and retransmission rate.

In another embodiment of the method of the present invention, combinable with any above described, the Root AP comprises a Steer Manager entity adapted to steering STAs and managing the hierarchy between Link Optimization and Load Balance routines' actions and steer requests, according to the priorities as follows:
i. Weak STA optimization;
ii. Load balance;
ii. Regular STA optimization.

In another embodiment of the method of the present invention, combinable with any above described, the Steer Manager is further configured to allow or deny the Link Optimization and Load Balance routines' actions on a particular STA based on the respective STA's previous behaviour.

In another embodiment of the method of the present invention, combinable with any above described, the Steer Manager maintains a queue of steer requests; for each request, a steering state is assigned accordingly such as:
Pending: request on queue to be sent;
Processing: request has been sent, waiting for reply;
Success: STA has been steered;
Failed: STA has not responded or has rejected the steer request.

In another embodiment of the method of the present invention, combinable with any above described, the Steering Manager is configured to execute procedure for managing steering requests, such requests being generated in the Link Optimization or in the Load Balance routines; said procedure comprising the following steps:
i. Checking if there is not current time penalty on the STA, and if so, the request is rejected;
ii. If there is no time penalty on the STA, it is checked if there are no conflicting requests;
iii. If there is a conflicting request, meaning that there is a similar request with the same STA, same source Basic service set and same target Basic service set, the new request is rejected if the old request with equal or higher priority in a pending or processing state exist; if said old request has a lower priority, the new request is rejected if the old request is in the processing state; if the old request is in pending state, the old request is deleted and the new request is accepted.

In another embodiment of the method of the present invention, combinable with any above described, if the STA does not respond to the steer request as expected, the Steering Manager is configured to mark such STA as ‘misbehaved’ for a predefined period of time, according to a following steer type:
Basic service set steer;
Legacy steer, which is a steer by deauthentication of STA from current Basic service set, and blacklisted by MAC address in every Basic service set that is not source or destination Basic service set.

In another embodiment of the method of the present invention, combinable with any above described, the steer response to a steer request is classified as one of the following:
Accept, if the STA is steered and reports a successful steer;
Reject, if the STA is not steered and reports a rejected steer;
Wrong Basic Service Set joined, if the STA joins a Basic Service Set different from the target Basic Service Set;
Disconnect, if the STA does not reconnect after a legacy blacklist;
Jump back, if the STA is steered to the target Basic Service Set but soon returns to the source Basic Service Set;
Timeout, if no response is obtained for the steer request.

The present invention also relates to a system for enhanced steering and traffic load balancing in wireless mesh networks. In a preferred embodiment of said system it is comprised by:
A Root AP
At least one Extender AP;

wherein,
The Root AP comprises a controller comprising processing means configured to execute the method for enhanced steering and traffic load balancing in wireless mesh networks developed, and to act as a master;
The Extender AP comprises at least one agent entity configured to act a slave and to exchange information with the controller.

As will be dear to one skilled in the art, the present invention, should not be limited to the embodiments described herein, and a number of changes are possible which remain within the scope of the present invention.

Of course, the preferred embodiments shown above are combinable, in the different possible forms, being herein avoided the repetition all such combinations.

1. Method for enhanced steering and traffic load balancing in wireless mesh networks, comprising the following steps:
vi. Root AP instructs periodically, the Extenders AP to report STAs' message status;
vii. Root AP wait for a predefined period of time until the requested messages status are received;
viii. Root AP kept a score history of all the STAs' message status received from the Extenders AP and updates it as the message status are being received;
ix. Root AP uses the updated score history of the STAs connected to the Extenders AP as an input to a Link Optimization routine and to a Load Balance routine, in order to decide which action is to be taken;
x. the steps i. to iv. are executed in a continuous loop until instructions otherwise from the Root AP.

2. Method according to claim 1, wherein the message status send by the Extenders AP to the Root AP includes metrics related to the connected STAs or the status of the wireless medium in which the Root AP is located.

3. Method according to claim 1, wherein the Link Optimization routine is programmed to execute a link optimization process comprising the following steps:
v. Calculate the current score of a link; the score being classified by the maximum throughput that a given STA would have via a given access point and band;
vi. Calculate target scores for every pair of {STA, fronthaul Basic Service Set};
vii. Evaluate if the highest score of a STA to a target AP is higher than the score of the STA to the current AP, and if so, evaluate if the throughput gain is better than in previous cases;
viii. Check if there is any steer required, following the step iii., and if required, a steer is requested for the pair {STA, target Basic Service Set}.

4. Method according to claim 3, wherein the maximum throughput is estimated considering:
signal strength;
maximum backhaul physical data rate; and
estimation of maximum theoretical physical data rate according to a STA and AP's capabilities;
wherein, the estimation of maximum theoretical physical data rate is as follows:
$${E}_{phy} ( s , {b}_{t} ) = \{ \begin{matrix}\frac{{M}_{phy} ( s , {b}_{t} )}{{2}^{H ( {b}_{t} )}} , & if {I}_{FH} ( {b}_{t} ) = {I}_{BH} ( {b}_{t} ) \\ {M}_{phy} ( s , {b}_{t} ) , & if {I}_{FH} ( {b}_{t} ) \neq {I}_{BH} ( {b}_{t} )\end{matrix}$$
where E_{phy} represents the Estimation, s represents the STA, bₜ represents the target BSS, M_{phy}(s, bₜ) represents the maximum theoretical physical data rate that can be obtained on the link between the STA s and the target BSS bₜ, according to each other's capabilities; H(bₜ) represents the distance of the AP that advertises the BSS in relation to the Root AP, in hops; I_{FH}(bₜ) refers to the interface that is used to advertise the target BSS (fronthaul), I_{BH}(bₜ) represents the interface used for backhaul communications.

5. Method according to claim 1, wherein the Link Optimization routine is further programmed to detect weak STAs based on the STA's metrics contained in the message status; said detection being based on the. RSSI of the STA's link.

6. Method according to claim 5, wherein weak STA's links are flagged and are handled by a Monitor Entity of the Link Optimization routine; said Monitor Entity being configured to:
to request the associated STA metrics for weak STAs in a higher frequency in relation to the requests of the base algorithm routine;
based on those requests, update the score history;
perform a link optimization assessment to evaluate if the weak STA is no longer weak; if so, the weak flag is removed.

7. Method according to claim 5, wherein weak STAs are not considered by the Load Balance routine.

8. Method according to claim 1, wherein the Load Balance routine is programmed to execute a load balance process comprised by two sequential stages:
iii. Saturated STA detection stage, by assessing if the STA is unable to achieve more throughput because the medium is overloaded;
iv. Throughput prediction stage, executed if saturated STAs are identified, and where a prediction score is computed for each potential target. AP.

9. Method according to claim 8, wherein the saturated STA detection stage is executed for all connected STAs' links and comprises the following steps:
v. Determine the amount of times a STA is classified as saturated within a time frame;
vi. Evaluate the saturation level to check whether or not a STA is saturated;
vii. If the STA is saturated it is marked as saturated.

10. Method according to claim 9, wherein the evaluation of the saturation level takes into account inputs including metrics from the STA under evaluation, such as
Airtime, transmission opportunity, retransmission rate, physical data rate, data rate, transmission failures, number of hops to Root AP and band;
and metrics from other STAs in the network, such as
Airtime and data rate;
in order to determine:
The available airtime;
The percentage of maximum airtime; and
The percentage of total data rate,
which are the inputs of a classification tree with two classes: saturated or not saturated STAs.

11. Method according to claim 8, wherein the throughput prediction stage comprises the following steps:
iv. Monitorization of saturated STAs for a specified amount of time, during which all the relevant metrics corresponding to the STAs under evaluation are stored;
v. Once the monitoring phase has expired, a target score is calculated for all available Aps, followed by a subsequent 2-step evaluation:
a. Check if the highest score of a saturated STA to a target AP is higher than the score of the STA to the current STA's throughput, measured during the monitoring phase;
b. Evaluate if the throughput gain is better than in previous cases where the condition of step a, was true;
vi. Check if there is any steer required; if required, a steer is requested for the pair {STA, target AP} where the throughput gain is the highest.

12. Method according to claim 4, wherein estimation of the highest score of a saturated STA combines the estimation of the maximum throughput, of the link optimization routine, with metrics that characterize the medium occupation such as transmission opportunity, available airtime and retransmission rate.

13. Method according to claim 1 wherein the Root AP comprises a Steer Manager entity adapted to steering STAs and managing the hierarchy between Link Optimization and Load Balance routines' actions and steer requests, according to the priorities as follows:
iv. Weak STA optimization;
v. Load balance;
vi. Regular STA optimization.

14. Method according to claim 13, wherein the Steer Manager is further configured to allow or deny the Link Optimization and Load Balance routines' actions on a particular STA based on the respective STA's previous behaviour.

15. Method according to claim 13, wherein the Steer Manager maintains a queue of steer requests; for each request, a steering state is assigned accordingly such as:
Pending: request on queue to be sent;
Processing: request has been sent, waiting for reply;
Success: STA has been steered;
Failed: STA has not responded or has rejected the steer request.

16. Method according to claim 13, wherein the Steering Manager is configured to execute procedure for managing steering requests, such requests being generated in the Link Optimization or in the Load Balance routines; said procedure comprising the following steps:
iv. Checking if there is not current time penalty on the STA, and if so, the request is rejected;
v. If there is no time penalty on the STA, it is checked if there are no conflicting requests;
vi. If there is a conflicting request, meaning that there is a similar request with the same STA, same source Basic service set and same target Basic service set, the new request is rejected if the old request with equal or higher priority in a pending or processing state exist; if said old request has a lower priority, the new request is rejected if the old request is in the processing state; if the old request is in pending state, the old request is deleted and the new request is accepted.

17. Method according to claim 13, wherein if the STA does not respond to the steer request as expected, the Steering Manager is configured to mark such STA as ‘misbehaved’ for a predefined period of time, according to a following steer type;
Basic service set steer;
Legacy steer, which is a steer by deauthentication of STA from current Basic service set, and blacklisted by MAC address in every Basic service set that is not source or destination Basic service set.

18. Method according to claim 17, wherein the steer response to a steer request is classified as one of the following:
Accept, if the STA is steered and reports a successful steer;
Reject, if the STA is not steered and reports a rejected steer;
Wrong Basic Service Set joined, if the STA joins a Basic Service Set different from the target Basic Service Set;
Disconnect, if the STA does not reconnect after a legacy blacklist;
Jump back, if the STA is steered to the target Basic Service Set but soon returns to the source Basic Service Set;
Timeout, if no response is obtained for the steer request.

19. System for enhanced steering and traffic load balancing in wireless mesh networks comprising:
A Root AP
At least one Extender AP;
wherein,
The Root AP comprises a controller comprising processing means configured to execute the method of claim 1 and to act as a master;
The Extender AP comprises at least one agent entity configured to act a slave and to exchange information with the controller.
